(19) United States
(12) Patent Application Publication
(10) Pub. No.: US 2012/0075254 A1
(43) Pub. Date: Mar. 29, 2012

(54) Touch System Having An Uninterrupted Light Source

(76) Inventors: Simon James Bridger, Auckland (NZ); Dris Adradi, Birkenhead (NZ)

(21) Appl. No.: 13/251,804

(22) Filed: Oct. 3, 2011

Related U.S. Application Data
(63) Continuation-in-part of application No. 13/153,910, filed on Jun. 6, 2011.
Application No. 13/153,910 is a continuation-in-part of application No. 12/350,220, filed on Jan. 7, 2009.
Application No. 12/350,220 is a continuation-in-part of application No. 12/319,546, filed on Jan. 7, 2009.
(60) Provisional application No. 61/019,404, filed on Jan. 7, 2008.

(30) Foreign Application Priority Data
Oct. 1, 2010 (AU) 2010904411

(51) Int. Cl. G06F 3/042

(52) U.S. Cl. 345/175

(57) ABSTRACT

According to the invention, an optical position sensing system is disclosed. The system may include a surface having a perimeter and a plurality of position sensing components. Each position sensing component may be located at a different point on the perimeter and include an optical sensor, a primary radiation source, and a supplemental radiation source. The supplemental radiation source may include retroreflective material or a discrete radiation source.

### CROSS-REFERENCE TO RELATED APPLICATIONS

This application claims priority to Australian Provisional Patent Application No. 2010904411 filed Oct. 1, 2010, entitled “A TOUCH SYSTEM HAVING AN UNINTERRUPTED LIGHT SOURCE,” the entire disclosure of which is hereby incorporated by reference, for all purposes, as if fully set forth herein.

This application is also a continuation-in-part of co-pending U.S. patent application Ser. No. 13/153,910 filed Jun. 6, 2011, entitled “SIMPLIFIED OPTICAL POSITION SENSING ASSEMBLY,” the entire disclosure of which is hereby incorporated by reference, for all purposes, as if fully set forth herein.

This application is also a continuation-in-part of co-pending U.S. patent application Ser. No. 12/350,220 filed Jan. 7, 2009, entitled “OPTICAL POSITION SENSING SYSTEM AND OPTICAL POSITION SENSOR ASSEMBLY,” which claims priority to U.S. Provisional Patent Application No. 61/019,404, filed Jan. 7, 2008, entitled “OPTICAL POSITION SENSOR WITH MINIATURE SENSOR,” the entire disclosures of which are hereby incorporated by reference, for all purposes, as if fully set forth herein.

This application is also a continuation-in-part of co-pending U.S. patent application Ser. No. 12/319,546 filed Jan. 7, 2009, entitled “OPTICAL POSITION SENSOR USING RETROFLECTION,” which claims priority to U.S. Provisional Patent Application No. 61/019,404, filed Jan. 7, 2008, entitled “OPTICAL POSITION SENSOR USING RETROFLECTION,” the entire disclosures of which are hereby incorporated by reference, for all purposes, as if fully set forth herein.

This application may be related to co-pending U.S. patent application Ser. No. 12/201,463 filed Aug. 29, 2008, entitled “OPTICAL TOUCHSCREEN WITH IMPROVED ILLUMINATION,” the entire disclosure of which is hereby incorporated by reference, for all purposes, as if fully set forth herein.

### TECHNICAL FIELD

The present invention relates generally to optical position detection systems, such as touch screens and interactive whiteboards. More particularly, the present invention relates to optical position detection systems with uninterrupted radiation and/or light sources.

### BACKGROUND OF THE INVENTION

Input means and methods for interactive devices including computers and the like have a long history of development. Conventional methods such as mice, keyboards and microphones have been in use for many years.

Recently, alternative forms of input devices have been developed such as touch sensitive devices which react to the presence of, or pressure from, a person's finger or pointing device to perform a command on a device. However, utilizing touch sensitive input devices to drive a computing device is not a new concept, for example the PLATO IV (Programmed Logic for Automated Teaching Operations) computing system used a touch screen which allowed users to touch certain points of the screen to perform commands as early as 1972.

Traditionally, touch sensitive input systems are incorporated in, or used in connection with, a display such as a cathode ray tube, liquid crystal display, plasma display, or any other type of display device. In these systems, interacting with the device often involved touching or pointing to graphical user interface ‘buttons’ shown on the display. In other instances, touch sensitive input devices are presented as a separate device to the display, such as a graphics pad or digitizer tablet.

One type of known touch sensitive input system is an optical touch system. Optical touch systems function by having at least one optical sensor which detects energy such as light emitted over a surface. When an object or pointer is placed on or near the surface, that energy is at least partially blocked. The optical sensor detects the absence of the energy and utilizes acquired data to determine the location of the blockage, and hence the location of the object or pointer. An example of an optical touch system is disclosed in U.S. Pat. No. 4,144,449 to Funk et al. in which light is emitted from tubes at the edges of a surface and a pair of linear image detectors observe the light to determine a pointer location based on where the light is blocked.

In a further advance to optical touch systems, a reflective or retroreflective material may be applied to the perimeter of the touch surface to reflect emitted energy back over the touch surface, thereby providing a more uniform energy distribution, which in turn allows for more accurate detection of pointer location. Because it is desirable in optical touch systems to provide as much data as possible from which the location of a touch or contact may be determined, multiple cameras may be provided at the edge of the touch surface thus providing multiple view points of a detected touch location. FIG. 1 shows such an optical touch system 100.

As shown in FIG. 1, cameras 110 are typically located at or adjacent to two or more corners of the surface 120. Retroreflective material 130 is applied around the perimeter of surface 120 (usually to a bezel or frame), and therefore the cameras 110 themselves form a break in light which is reflected back to each other camera 110. In FIG. 1, light is shown transmitted from camera 110a in a fan across surface 120, and specific light paths are shown by arrows 140. While arrows A and B show that light is easily reflected by retroreflective material 130 back to camera 110a, less light is reflected back on paths X, Y, and Z. The same effect occurs for light detected at each camera 110 in a similar fashion.

The resulting drop in received light from camera 110a can be seen from FIG. 2 which shows experimental data 200 from a like situated camera in a similar optical touch system. As shown in FIG. 2, the light levels received from the direction of corners X, Y, and Z are markedly lower than light levels received from retroreflective material 130 along the edges of surface 120 between corners X, Y, and Z (paths A and B). Consequently, the presence of a light-blocking touch input located along these directional vectors may be more difficult to detect because there is little or no light to block from camera 110a in these directions. Each camera 110 in system 100 may experience a similar detrimental effect because of the presence of the other cameras 110.

The present invention attempts to at least partially overcome the aforementioned disadvantages of previous optical touch sensitive displays.

### BRIEF DESCRIPTION OF THE INVENTION

In one embodiment, an optical position sensing system is provided. The system may include a surface, possibly a video display, having a perimeter and a plurality of position sensing components. Each position sensing component may be located at a different point on the perimeter and include an optical sensor, a primary radiation source, and a supplemental radiation source. The supplemental radiation source may include retroreflective material or a discrete original radiation source.

In another embodiment, a method for sensing the position of an object near a surface is provided. The method may include transmitting radiation across the surface from a first primary radiation source of a first sensing component and a second primary radiation source of a second sensing component. The method may also include transmitting radiation across the surface from each of a first supplemental radiation source of the first sensing component and a second supplemental radiation source of the second sensing component. The method may further include receiving, at the first sensing component, radiation from both the first primary radiation source and the second supplemental radiation source. The method may additionally include receiving, at the second sensing component, radiation from both the second primary radiation source and the first supplemental radiation source.

### BRIEF DESCRIPTION OF THE DRAWINGS

The present invention is described in conjunction with the appended figures:

FIG. 1 is an illustration of an optical position sensing system;

FIG. 2 is a graph showing signal levels received by a camera in a system similar to that shown in FIG. 1;

FIG. 3 is an illustration of an exemplary position sensing system of the invention;

FIG. 4 is an illustration of one possible position sensing component of the invention which employs a passive supplemental radiation source;

FIG. 5 is an illustration of another possible position sensing component of the invention which employs an active supplemental radiation source; and

FIG. 6 is a graph showing signal levels received by a camera in a system similar to that shown in FIG. 3.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The present invention provides novel position sensing components and optical position sensing systems incorporating those components. The position sensing components of the present invention provide a supplemental light source which works to counteract the typical lack of retroreflective properties in prior art position sensing components. Consequently, the position sensing components and optical position sensing systems of the present invention may be suitable for use with touch sensitive displays on various devices, including, but not limited to, interactive displays, computers, mobile phones, personal data assistants, gaming equipment, data entry devices, and other devices which benefit from providing touch input means to users.

Reference will now be made in detail to various and alternative exemplary embodiments and to the accompanying drawings, with like numerals representing similar structural elements. Each example is provided by way of explanation, and not by limitation. It will be apparent to those skilled in the art that modifications and variations can be made to the described embodiments without departing from the scope or spirit of the disclosure and claims herein. For instance, features illustrated or described as part of one embodiment may be used in connection with another embodiment to yield additional embodiments. Thus, it is intended that the present disclosure includes modifications and variations as come within the scope of the appended claims and their equivalents.

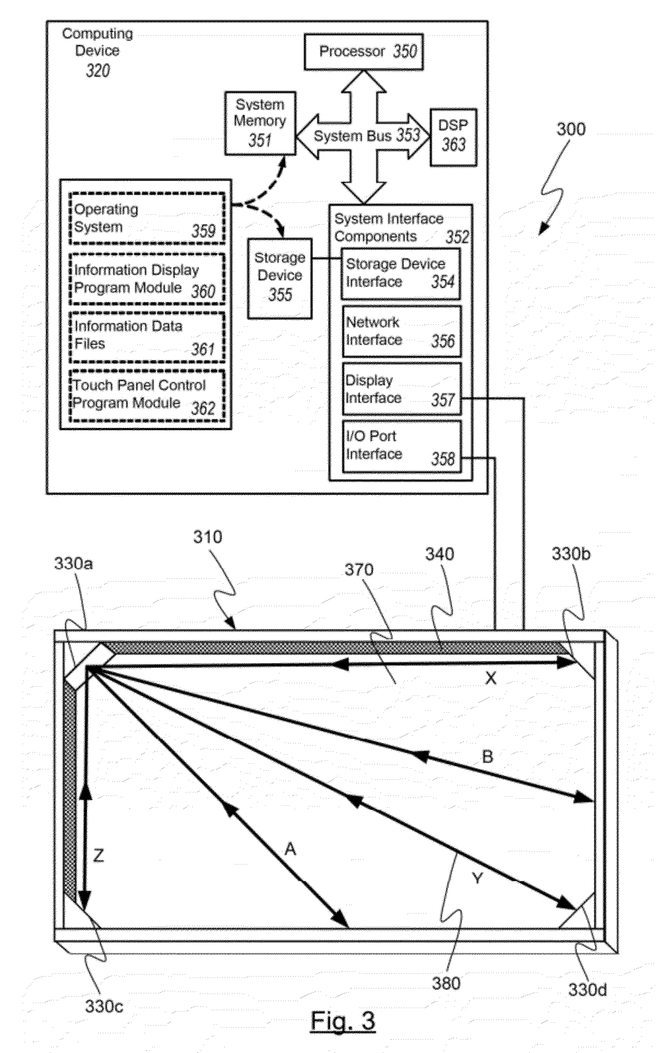

Turning now to FIG. 3, an illustration of an exemplary position sensing system is shown, referred to hereinafter as a touch screen system 300. As used herein, the term “touch screen system” is meant to refer to a touch screen including hardware and/or software components that provide position sensing or touch detection functionality. Exemplary touch screen system 300 includes a touch screen 310 interfaced to a computing device 320, which may execute software for detecting touches (i.e., sensing the position of a pointer) on or near touch screen 310. Touch screen 310 may be positioned in front of or integrated with a display device employed by computing device 320, so that a user can view and interact with the visual output of the display device through the touch screen 310.

Touch screen system 300 relies on a combination of electromagnetic radiation, reflectors (including retroreflectors), optical sensors, digital signal processing, and algorithms to determine the position of a pointer within a viewing area. In the illustrated embodiment, touch screen 310 includes position sensing components 330 located in each of its four corners. In other embodiments, touch screen 310 may include position sensing components 330 located in two or more of its four corners or sides. Touch screen 310 also includes a bezel on the remaining perimeter having retroreflective material 340 applied thereto. Retroreflective material 340 may be applied to any particular side of the bezel, or all sides of the bezel, within the field of view of one or more of the position sensing components 330, even though it is only visible on two sides of the bezel from the perspective shown in FIG. 3. Each position sensing component 330 may include a primary radiation source, an optical sensor, and a supplemental radiation source.

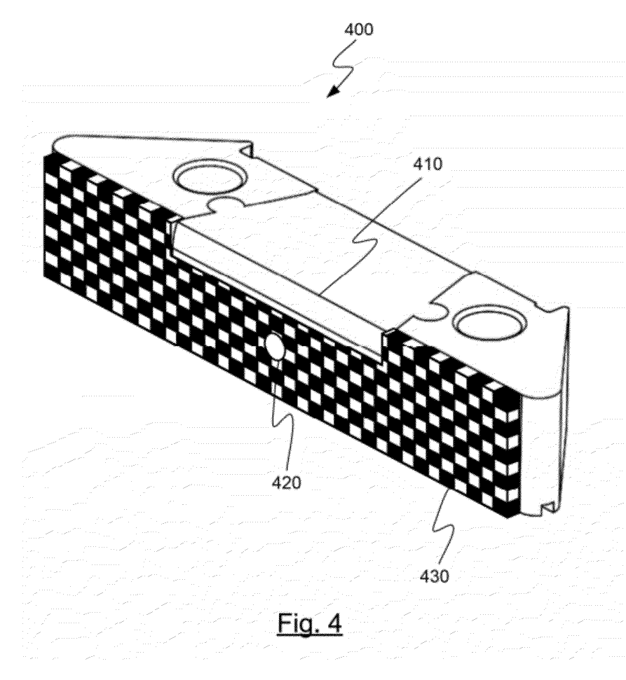

FIG. 4 illustrates one possible position sensing component 400 of the invention. Position sensing component 400 includes a primary radiation source 410, an optical sensor 420, and a supplemental radiation source 430. Primary radiation source 410 may include any number of possible electromagnetic radiation sources that emit different wavelengths of radiation, possibly light in the visible or invisible (e.g., ultraviolet or infrared) spectrums. Merely by way of example, primary radiation source 410 may be a light emitting diode.

Optical sensor 420 may be a line scan or area scan camera. Merely by way of example, optical sensor 420 may be at least based on a complementary metal oxide semiconductor, a charge coupled device, and/or a charge injection device.

Supplemental radiation source 430 is shown in this embodiment as being a retroreflective surface. The retroreflective surface may be any embossment, finish, constructions, or otherwise that causes radiation which encounters the retroreflective surface to return radiation at least generally back towards the source of the radiation. In another example construction, a retroreflective surface may be located inside position sensing component 400 behind a window or lens (which may be transparent or translucent or may filter light of different wavelengths, frequencies, etc.) on the exterior of position sensing component 400. As used herein, “radiation” refers to electromagnetic energy such as visible or invisible (e.g., ultraviolet or infrared) light. Whenever the term “light” is used herein, it may also be interpreted to mean other types of radiation as will be apparent to one of skill in the art.

In other embodiments, primary radiation source 410 may be located behind the retroreflective surface of supplemental radiation source 430, and transmit the primary radiation through the retroreflective surface. By way of example, a retroreflective material with a non-metalized backing may be suitable for such an embodiment. In this manner, the entire face of position sensing component 400 may be covered by a retroreflective surface, increasing the effectiveness of supplemental radiation source 430.

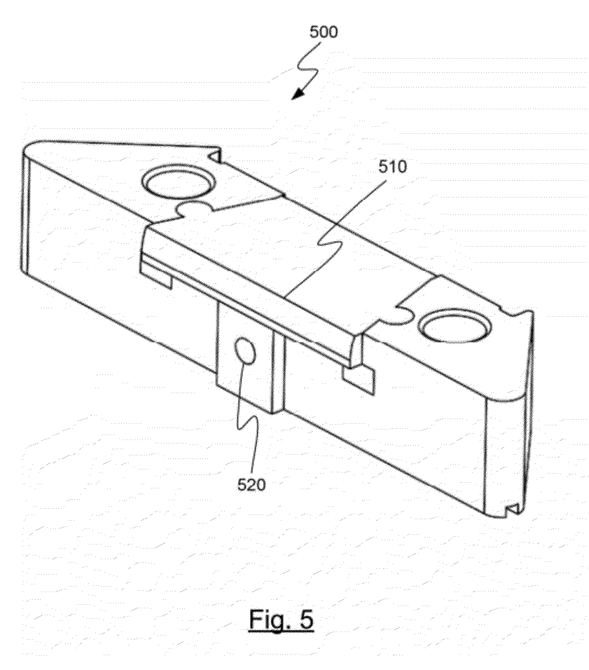

FIG. 5 illustrates another possible position sensing component 500 of the invention. Position sensing component 500 includes a radiation source 510 and optical sensor 520. Radiation source 510 may act as both the primary radiation source and supplemental radiation source of position sensing component 500. The operation of radiation source 510 as both the primary radiation source and supplemental radiation source of position sensing component 500 will be discussed in greater detail below.

As above with primary radiation source 410, radiation source 510 may include any number of possible electromagnetic radiation sources that emit different wavelengths of radiation Merely by way of example, radiation source 510 may be a light emitting diode. In another example construction, a retroreflective surface may be located on the exterior of position sensing component 400, and the primary/supplemental radiation source 510 may transmit radiation through the retroreflective surface. In this manner, both the retroreflective surface and the radiation source may act as the supplemental radiation source of position sensing component 500. In yet other embodiments, an additional radiation source may be provided in position sensing component 500, with radiation source 510 acting as the primary radiation source, and the additional radiation source acting as the supplemental radiation source.

As above with optical sensor 420, optical sensor 520 may be a line scan or area scan camera. Merely by way of example, optical sensor 520 may be at least based on a complementary metal oxide semiconductor, a charge coupled device, and/or a charge injection device.

Returning to FIG. 3, radiation from the primary radiation sources of position sensing components 330 is guided throughout the viewing area by reflectors 340 on the bezel or other suitable radiation/light guide means. The radiation thus “illuminates” a plane that is in close proximity and/or parallel to the viewing area of the display screen 310. A pointer or other object placed within or sufficiently near the viewing area disturbs the illumination and creates a shadow effect that can be detected by the optical sensors of position sensing components 330. The position of the shadow, which corresponds to a touch point, can be determined through signal processing and software algorithms.

Position sensing components 330 thus transmit data regarding detected radiation and shadows to computing device 320 that executes hardware and software for processing said data and calculating the location of a touch input. Computing device 320 may be functionally coupled to touch screen 310 by hardwire or wireless connection. In various embodiments, computing device 320 may constitute at least some portion of a processor-driven device, such as a personal computer, a laptop computer, a handheld computer, a personal digital assistant, a digital and/or cellular telephone, a pager, a video game device, etc. These and other types of processor-driven devices which may employ the systems and methods of the invention will be apparent to those of skill in the art. As used in this discussion, the term “processor” can also refer to any type of programmable logic device, including microprocessors, field programmable gate arrays, and/or any other similar device.

Computing device 320 may include, for example, a processor 350, system memory 351 and various system interface components 352. Processor 350, system memory 351 and system interface components 352 may be functionally connected via system bus 353. System interface components 352 may also enable processor 350 to communicate with peripheral devices. For example, a storage device interface 354 can provide an interface between processor 350 and storage device 355 (e.g., a removable or non-removable non-transitory storage drive). A network interface 356 may also be provided as an interface between processor 350 and a network communications device (not shown), so that the computing device 320 may be connected to a network.

Display interface 357 may provide an interface between the processor 350 and a display device, such as a computer monitor or other display device. One or more input/output (“I/O”) port interfaces 358 may be provided as an interface between processor 350 and various input and/or output devices. In the example embodiment shown, the display of touch screen 310, as well as position sensing components 330, and any other suitable components of touch screen 310 are communicatively coupled with computing device 320 via both the display interface 357 and I/O port interface 358. In this manner, the display element of touch screen 310 communicates with computing device 320 via display interface 357, and the touch sensing element of touch screen 310 communicates with computing device via I/O port interface 358.

A number of program modules may be stored in system memory 351 and/or any other computer-readable media via storage device interface 354. The program modules may include an operating system 359, an application program module 360 which includes computer-executable instructions for displaying images or other information on a display screen, and miscellaneous information data files 361 for both operating system 359 and application program module 360. Touch panel control program module 362 may also be stored in various system components, thereby allowing for control and data acquisition from position sensing components 330 of touch screen 310 as further described herein. Touch panel control program module 362 may also include the software/logic necessary for calculating the locations of touch inputs or cursor positions at touch screen 310.

Certain embodiments may also include a digital signal processing unit (DSP) 363 for performing some or all of the functionality ascribed to touch panel control program module 362. As known in the art, DSP 363 may be configured to perform many types of calculations including filtering, data sampling, and triangulation and may be used to control the modulation of the radiation sources of the position sensing components 330. DSP 363 may include a series of scanning imagers, digital filters, and comparators implemented in software. DSP 363 may therefore be programmed for calculating touch locations and cursor positions relative to the touch screen 310, as described herein. Those of skill in the art will understand that the functions of DSP 363 may also be implemented by other means, such as by operating system 359, by another driver or program module running on the computing device 320, or by a dedicated touch screen controller device. These and other means for calculating touch locations and cursor positions relative to a touch screen 310 are contemplated by embodiments of the present invention.

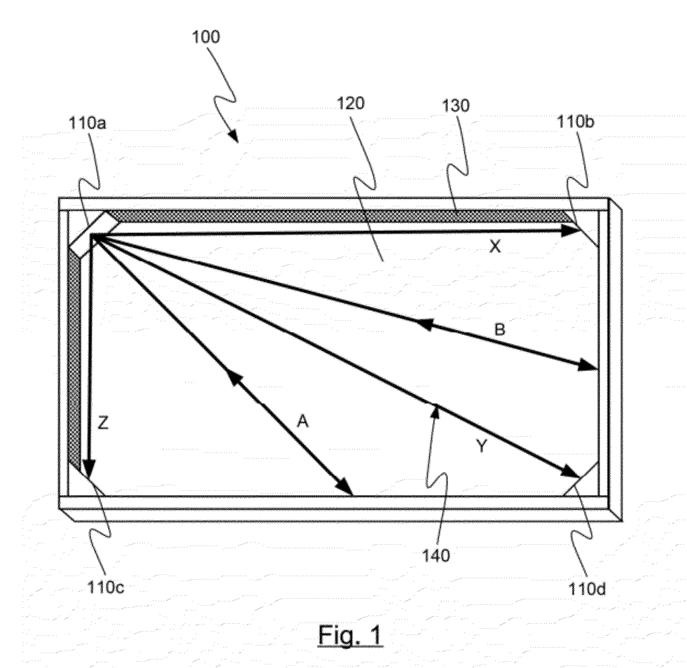

In operation then, with reference to FIG. 3, each of position sensing components 330 transmits a fan of radiation via its primary radiation source across surface 370. Example vectors of this radiation from position sensing component 330a are shown in FIG. 3 as arrows 380. As in FIG. 1, arrows A and B show radiation reflecting back toward position sensing component 330a after encountering retroreflective material 340 on the bezel. However, unlike FIG. 1, radiation is returned in greater amounts from corner directions X, Y, and Z. This is due to the supplemental radiation sources present at each position sensing component 330 located at the respective corners.

These supplemental radiation sources may be either passive or active radiation sources. Example of passive radiation sources include, merely by way of example, retroreflective material, similar to, or the same as, the retroreflective material 340 on the bezel. Position sensing component 400 of FIG. 4 includes retroreflective material 420 in this fashion. Examples of active radiation sources include, merely by way of example, discrete original radiation sources such as light emitting diodes or other powered radiation sources that originate electromagnetic radiation. Position sensing component 500 of FIG. 5 includes a discrete original radiation source 510 in this fashion.

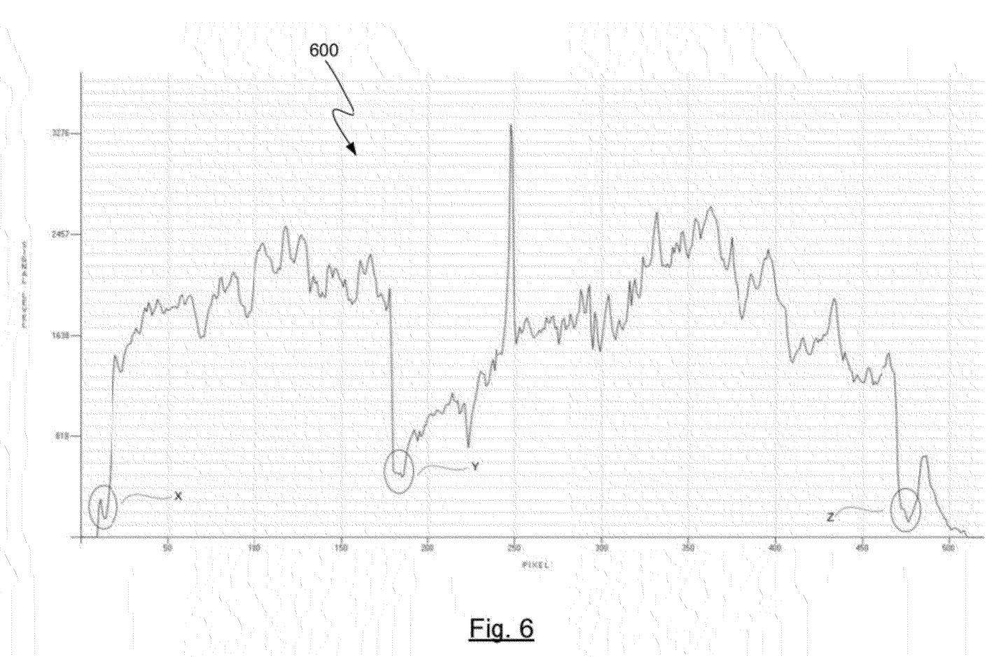

Thus, in operation, the supplemental radiation sources of position sensing components 330b, 330c, and 330d supplement the radiation transmitted by a primary radiation source of position sensing component 330a. In this manner, the amount of baseline radiation received back at the optical sensor of position sensing component 330, in the absence of a touch input on touch screen 310, may be increased as shown in FIG. 6.

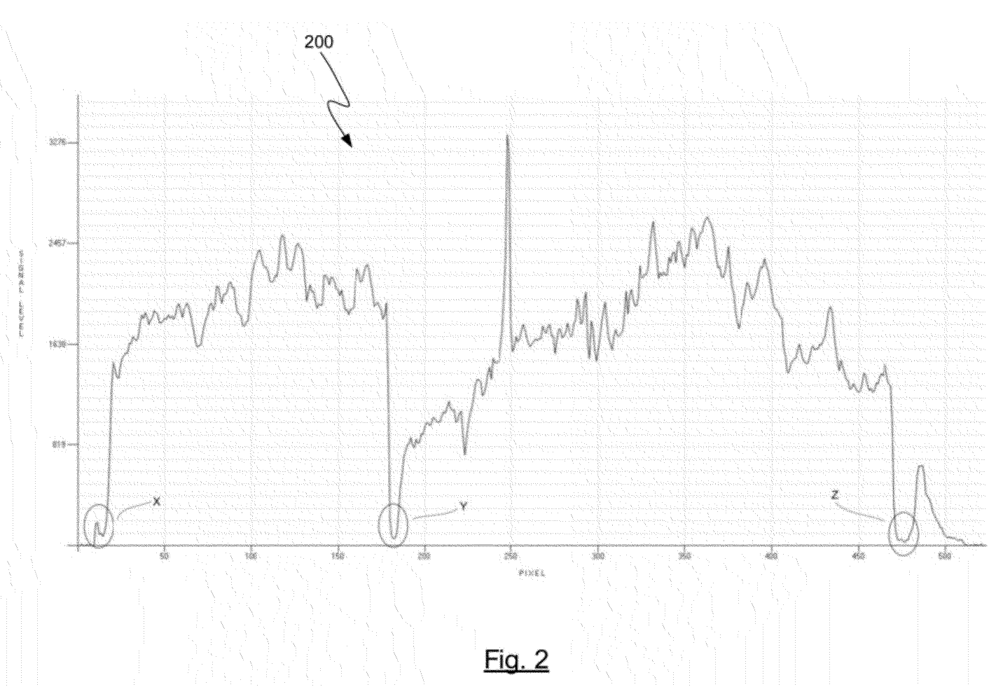

FIG. 6 shows experimental data 600 from a like situated camera in a similar optical touch system to FIG. 3 where the position sensing components 330 are equipped with supplemental radiation sources. While the improvements in light received from vectors X, Y, and Z at position sensing component 330a are modest over that shown in FIG. 2, the demonstrated improvement increases the likelihood that the algorithms of computing device 320 will be able to detect and correctly process an affirmative touch input on touch screen 310. Because the background light levels received from the corners of touch screen are higher in the embodiment shown in FIG. 3, a touch input located on vectors X, Y, or Z will create a larger, more noticeable/detectable difference (delta) at the optical sensor of position sensing component 330a. The same effect will occur for each position sensing component 330, thereby increasing the overall sensitivity, resolution, and effectiveness of touch screen system 300.

While passive supplemental radiation sources, as shown in the example of FIG. 4, may improve the operation of touch screen system 300 without further interaction or control by computing device 320, active supplemental radiation sources, as shown in the example of FIG. 5 may be controlled in various schemes by computing device 320. Merely by way of example, the operation of all position sensing components 330 may be phased so that only one is receiving optical signals at any given time. Such phasing may be very quick, thereby simulating near continuous operation by each position sensing component 330. In this manner, when one position sensing component 330 is actively receiving radiation signals via its optical sensor, its own primary radiation source is active, while the supplemental radiation source of the remaining position sensing components are active.

Thus, the any active position sensing component 330 will receive radiation originated from its own primary radiation source which has been reflected back to it from retroreflective material 340 on the bezel, as well as supplemental radiation as produced by the supplemental radiation sources of the other position sensing components 330. As discussed herein, the supplemental radiation may be (1) radiation reflected back from passive supplemental radiation sources at the other position sensing components 330, and/or (2) radiation originating from active original discrete supplemental radiation sources at the other position sensing components 330. Thus, as described above with reference to FIG. 5, in embodiments where the supplemental radiation source of a position sensing component 330 is an active radiation source, such active radiation source may be both the primary radiation source for that particular position sensing component 330, and the supplemental radiation source for other position sensing components 330.

In other embodiments, instead of phased operation, active original discrete supplemental radiation sources may be continuously active during operation of touch screen system 300. In these embodiments, each supplemental radiation source may transmit radiation with a common wavelength or with different wavelengths corresponding to different optical sensors of different position sensing components 330. In these embodiments, each position sensing component 330 may therefore be assigned a certain wavelength of radiation to which its optical sensor is responsible. Active radiation sources at each position sensing component 330 may be configured to deliver (1) the required primary radiation in a first wavelength for that position sensing component 330, and (2) the required supplemental radiation in another wavelength or wavelengths for other position sensing components 330.

In some embodiments, the primary radiation source, supplemental radiation source, or optical sensor of one or more of the position sensing components 330 may be angled relative to the plane of the touch screen 310 in order to optimize reception at any other particular optical sensor of primary and/or supplemental radiation. However, in most embodiments, the primary radiation source, supplemental radiation source, and optical sensor of each position sensing component will be co-located at the same perimeter point of touch screen 310, only stacked in various configurations perpendicular to the plane of the screen.

In the aforementioned embodiments then, supplemental radiation sources of each position sensing component 330 work to counteract the typical “dead spot” in the linear spectrum of received radiation at each optical sensor. Because the usual received radiation at an optical sensor is radiation reflected back from each optical sensor's primary radiation source, dead spots result from the extreme angles of incidence at other corners, as well as the presence of less reflective position sensing assemblies at those locations. The supplemental radiation sources at each of these dead spots, whether passive or active as described above, at least partially fills the dead spots, thereby increasing optical sensitivity along the vector from the active optical sensor to the particular corner. While the above disclosure mostly describes embodiments employing position sensing components 330 at each corner, fewer or greater number of position sensing components 330 may be employed in other embodiments. For example, in various embodiments, only two opposing corners may be provided with position sensing components 330, only two adjacent corners may be provided with position sensing components 330, not all corners of a surface may be provided with position sensing components 330, and/or other position sensing components 330 may be located at various points along the sides of the surface.

Based on the foregoing, it can be seen that the present invention provides performance enhancements for a optical position sensing systems. Many other modifications, features and embodiments of the present invention will become evident to those of skill in the art after consideration of this disclosure. Accordingly, it should be understood that the foregoing relates only specifically to certain embodiments of the invention, and generally to many other embodiments of the invention. Thus, the specific embodiments discussed herein are presented by way of example, rather than by way limitation. Numerous changes may be made to the exemplary embodiments described herein without departing from the spirit and scope of the invention as defined by the following claims.

What is claimed is:

1. An optical position sensing system, comprising:
a surface having a perimeter; and
a plurality of position sensing components, wherein:
each position sensing component is located at a different point on or adjacent to the perimeter; and
each position sensing component comprises:
an optical sensor;
a primary radiation source; and
a supplemental radiation source.

2. The optical position sensing system of claim 1, wherein the supplemental radiation source comprises retroreflective material.

3. The optical position sensing system of claim 2, wherein the retroreflective material is disposed on an external surface of at least one position sensing component.

4. The optical position sensing system of claim 2, wherein the retroreflective material is disposed internally within at least one position sensing component behind a window or a lens of the at least one position sensing component.

5. The optical position sensing system of claim 1, wherein the supplemental radiation source comprises a discrete radiation source.

6. The optical position sensing system of claim 5, wherein the discrete radiation source comprises a light emitting diode.

7. The optical position sensing system of claim 5, wherein the discrete radiation source is activated intermittently during operation of the optical position sensing system.

8. The optical position sensing system of claim 5, wherein the discrete radiation source is activated continuously during operation of the optical position sensing system.

9. The optical position sensing system of claim 1, wherein the primary radiation source comprises a discrete light source.

10. The optical position sensing system of claim 1, wherein the primary radiation source is disposed behind a retroreflective material, wherein at least a portion of radiation transmitted by the primary radiation source passes through the retroreflective material.

11. The optical position sensing system of claim 1, wherein the optical sensor and the supplemental radiation source are each substantially located on a common axis perpendicular to the surface.

12. The optical position sensing system of claim 11, wherein the surface defines a plane, and a reception face of the optical sensor or a transmission face of the supplemental radiation source is not perpendicular to a plane of the surface.

13. The optical position sensing system of claim 11, wherein the optical sensor is located above the supplemental radiation source.

14. The optical position sensing system of claim 11, wherein the optical sensor is located below the supplemental radiation source.

15. The optical position sensing system of claim 1, wherein the surface comprises a display.

16. The optical position sensing system of claim 1, wherein the plurality of position sensing components comprises four position sensing components, each position sensing component located at a different corner of the surface.

17. A method for sensing the position of an object near a surface, wherein the method comprises:
transmitting radiation across the surface from a first primary radiation source of a first sensing component and a second primary radiation source of a second sensing component;
transmitting radiation across the surface from each of a first supplemental radiation source of the first sensing component and a second supplemental radiation source of the second sensing component;
receiving, at the first sensing component, radiation from both the first primary radiation source and the second supplemental radiation source; and
receiving, at the second sensing component, radiation from both the second primary radiation source and the first supplemental radiation source.

18. The method for sensing the position of an object near a surface of claim 17, wherein receiving, at the first sensing component, radiation from the first primary radiation source comprises receiving radiation from the first sensing component which has been reflected back to the first sensing component.

19. The method for sensing the position of an object near a surface of claim 17, wherein receiving, at the first sensing component, radiation from the second supplemental radiation source comprises receiving radiation from the first sensing component which has been reflected back to the first sensing component.

20. The method for sensing the position of an object near a surface of claim 17, wherein the receiving, at the first sensing component, radiation from the second supplemental radiation source comprises receiving radiation from a discrete original radiation source.

21. The method for sensing the position of an object near a surface of claim 17, wherein receiving radiation at the first sensing component occurs at a different time than receiving radiation at the second sensing component.
